(19) United States
(12) Patent Application Publication
(10) Pub. No.: US 2008/0212584 A1
(43) Pub. Date: Sep. 4, 2008

(54) Method and system for presentation of multicast trees

(75) Inventors: Lee Breslau, Basking Ridge, NJ (US); William C. Fenner, Woodside, CA (US)

Correspondence Address: SCHWEGMAN, LUNDBERG & WOESSNER, P.A., P.O. BOX 2938, MINNEAPOLIS, MN, 55402, US

(73) Assignee: AT&T Knowledge Ventures, L.P.

(21) Appl. No.: 11/713,171

(22) Filed: Mar. 2, 2007

(51) Int. Cl. H04L 12/56

(52) U.S. Cl. 370/390

(57) ABSTRACT

A method and system for rendering a plurality of multicast trees for presentation on a display. A multicast routing state may be accessed from a plurality of routers in a multicast group. The multicast routing state may include identification of at least one of an upstream router or a downstream router. A plurality of multicast trees may be identified from the multicast routing state of the plurality of routers. Each of the plurality of multicast trees may indicate a plurality of paths for a data packet from an originating router to selected routers among the plurality of routers. At least two of the plurality of multicast trees may be rendered on a display as an overlapping multicast tree. The overlapping multicast tree may include the plurality of paths for the data packet from the originating router to the selected routers for each of the at least two of the plurality of multicast trees.

### FIELD

This application relates to methods and systems for multicast network communication, and more specifically to systems and methods for presentation of multicast trees.

### BACKGROUND

Internet Protocol (IP) multicasting provides a useful way for a source to transmit a stream of data packets to a group of recipients. A group of receivers subscribe to a particular multicast transmission to receive the data packets from a source. The individual receivers of the group need not physically or geographically be located near one another. Similarly, the data packets can be transmitted to the group from one or more sources located virtually anywhere, as long as they can communicate with the receivers, through a common network of computers, such as the Internet. Rather than transmitting multiple copies of data packets to each receiver, as in unicast, multicast transmits one copy of its data packets to a group address. Multicast group addresses are reserved IP addresses in the range of 224.0.0.0-239.255.255.255.

Within enterprise networks, multicast technology may be used to support applications including audio and video distribution of employee meetings, small group conferencing, software distribution, dissemination of financial market data, and the like. Within service provider networks, multicast technology may be used to support multicast capability within Virtual Private Network (VPN) service. Multicast may also be used in other types of networks and/or to support other applications.

Multicast is a complex system. The set of multicast groups active in a network is dynamic, as are the sets of senders and receivers in each multicast group. Hence, routing state, which is distributed across many routers in the network, is ever changing and difficult to know. In such an environment, knowing whether multicast service is functioning properly is not easy. Data loss in multicasting can result from several occurrences, including congestion in the network and Internet Service Providers (ISPs) improperly conveying multicast data packets.

The distribution of routers in a multicasting session generally has a tree-like configuration with numerous branches. This is generally referred to as a multicast tree. In this configuration, due to the nature of multicast, when data packets are lost in transit, all recipients on downstream branches from that point lose the same packets. When a problem arises, identifying the location of the problem, identifying its cause, and providing a solution are difficult because multiple multicast trees may be involved in distribution of a particular packet.

### BRIEF DESCRIPTION OF DRAWINGS

Embodiments are illustrated by way of example and not limitation in the figures of the accompanying drawings, in which like references indicate similar elements and in which:

FIG. 1 is a flowchart illustrating a method for displaying a plurality of multicast trees in accordance with an example embodiment;

FIGS. 2 & 3 are flowcharts illustrating method for rendering an overlapping multicast tree in accordance with example embodiments;

FIGS. 4 & 5 are example embodiments of overlapping multicast trees;

FIG. 6 is a flowchart illustrating a method for rendering an overlapping multicast tree in accordance with an example embodiment;

FIGS. 7 & 8 are example embodiments of an overlapping multicast trees;

FIG. 9 is a flowchart illustrating a method for rendering an overlapping multicast tree in accordance with an example embodiment;

FIG. 10 is a flowchart illustrating a method for addressing a problem in a network in accordance with an example embodiment;

FIG. 11 is a block diagram of an example administration application;

FIG. 12 is a block diagram of an IPTV system of which a plurality of multicast trees may be displayed in accordance with an example embodiment; and

FIG. 13 illustrates a diagrammatic representation of machine in the example form of a computer system within which a set of instructions, for causing the machine to perform any one or more of the methodologies discussed herein, may be executed.

### DETAILED DESCRIPTION

Example methods and systems for presentation of a plurality of multicast trees are described. In the following description, for purposes of explanation, numerous specific details are set forth in order to provide a thorough understanding of example embodiments. It will be evident, however, to one skilled in the art that the present invention may be practiced without these specific details.

An overlapping multicast tree may be rendered for presentation on a display from a plurality of multicast trees identified from a multicast routing state accessed from a plurality of routers to support the deployment, monitoring, troubleshooting and debugging of multicast technology on a network. The overlapping multicast tree may be used by an administrator to verify that data packets are being delivered to specified locations. When distribution fails, the overlapping multicast tree may be useful in determining the location and cause of the failure on the network.

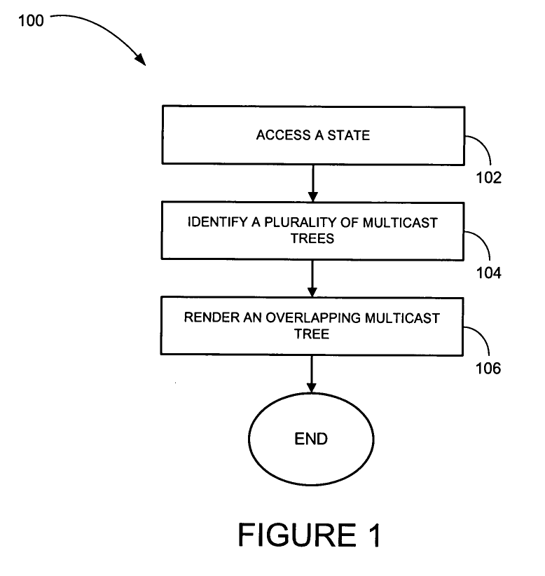

FIG. 1 illustrates a method 100 for displaying a plurality of multicast trees according to an example embodiment.

A multicast routing state may be accessed from a plurality of routers in a multicast group at block 102. The multicast routing state of a particular router may be accessed by querying the particular router. In an example embodiment, a multicast group address and an address of at least one sender may be used to access a multicast routing state from a plurality of routers in a multicast group.

The multicast routing state of a particular router may include identification of zero or more upstream routers from which a data packet may be received and/or zero or more downstream routers to which a data packet may be sent. However, the multicast routing state may also include other information. A particular router may use the multicast routing state to decide which data packets to discard or which data packets to forward and how to forward them.

A plurality of multicast trees may be identified from the multicast routing state of the plurality of routers at block 104. A multicast tree may define how the data packets are replicated and forwarded in a network and be characterized as either a source tree or a shared tree. A source tree is a multicast tree that pertains to a single source, while a shared tree is a multicast tree that can pertain to any source. Source trees may be referred to as “(S,G)” trees, and shared trees may be referred to as “(*,G)” trees.

A shared tree may be identified using the multicast group address and at least one source tree may be identified using the address of at least one sender. The routing table entries that collectively determine the multicast tree specify a source (e.g., using the source's IP address), and data packets whose source IP address match that source are forwarded along a plurality of paths from an originating router to selected routers using those routing table entries. Routing table entries for shared trees are used to forward data packets along a path from all sources, except in the case when a source tree exists for a particular source.

Different multicast routing protocols may use different kinds of multicast trees. Some protocols use shared trees exclusively, others use source trees exclusively, and some use a combination of both. For example, PIM Sparse Mode (PIM-SM), uses a combination of source and shared trees.

By way of example, the plurality of multicast trees may be identified (e.g., discovered) at block 104 by using a multicast group address, G, and the addresses of one or more sources, S1, . . . , Sn, currently sending to that multicast group. Each of the multicast trees may be identified in an abstract format which includes the group address, the source address, each of the nodes in the multicast tree, and the plurality of paths connecting nodes in the tree. The abstract tree descriptions may be used for rendering the multicast trees for presentation on a display.

At least two of the plurality of multicast trees may be rendered (e.g., in a single display simultaneously) as an overlapping multicast tree at block 106. In an example embodiment, the overlapping multicast tree may be a simultaneous representation of a plurality of multicast trees sharing at least one router in one or more multicast groups in a tree-like form.

The overlapping multicast tree may include the plurality of paths for the data packet from the originating router to the selected routers for each of the at least two of the plurality of multicast trees. Rendering at least two of the plurality of multicast trees on a display may include electronically presenting (e.g., displaying) on the display the routers and plurality of paths of the at least two of the plurality of multicast trees as an overlapping multicast tree. The presentation of the at least two multicast trees as an overlapping multicast tree on the display may enable the administrator to understand how and where the plurality of multicast trees meets and overlap. An example embodiment of rendering at least two multicast trees as an overlapping multicast tree for presentation on a display is described in greater detail below.

Routers that are a member of at least one of the multicast trees may be displayed using a specified shape (e.g., an oval) labelled with the name of the router. The root of the shared tree, which is commonly referred to as the Rendezvous Point and which serves a special purpose in the PIM-SM protocol, may be labelled with a distinct shape. Each tree may be assigned a format (e.g., a unique color, distinctive lines, or other identifier). For each path in each tree, a line or curve is drawn in the format assigned to that tree between the two endpoints of the path. An arrow may be used to indicate the direction of the packet flow (e.g., arrows may point away from the root of each multicast tree.)

By way of example, a packet transmitted by a source with PIM-SM may be forwarded from the source to all receivers entirely on a source tree. However, commonly, a packet will be forwarded along a source tree part of or all of the way to some destinations, and then forwarded along a shared tree to some or all destinations. In this case, the data path followed by a data packet is not on a single source or shared tree. Rather the overlapping multicast tree may consist of the union of the source tree and a subset of the shared tree (as determined by the PIM-SM packet forwarding rules.) The overlapping multicast tree may be used for PIM-SM to present the plurality of paths for data packets.

Upon completion of the operations at block 106, the method 100 may terminate.

In an example embodiment, an information request for a router of the plurality of routers may be received, and information regarding the multicast routing entry of the chosen router may be presented on a display in response to the information request. The information provided may be of additional use to an administrator in trying to diagnosis a problem with a router in multicast group.

The method 100 may be used to display multiple multicast trees for the same multicast group, or to concurrently display multicast trees from multiple multicast groups simultaneously. For example, when two multicast groups are used by the same application, a network administrator may display them concurrently (e.g., to see if they are reaching the same endpoints or to see if they are following the same path through the network).

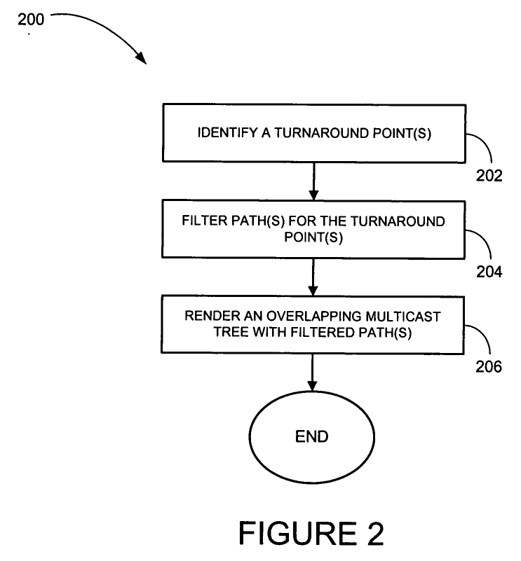

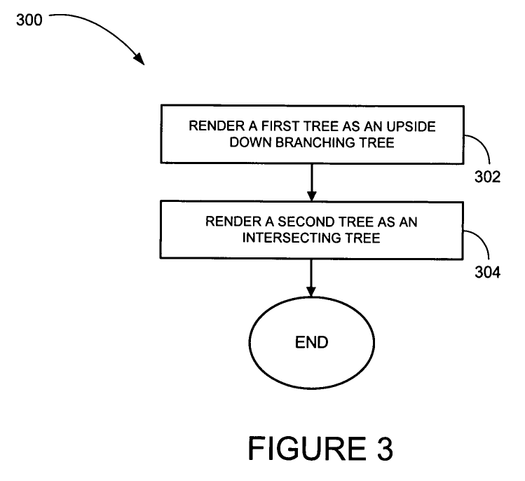

FIG. 2 illustrates a method 200 for rendering an overlapping multicast tree according to an example embodiment. In an example embodiment, the method 200 may be performed at block 106 (see FIG. 1).

At least one turnaround point may be identified on at least two of the plurality of multicast trees at block 202. The at least one turnaround point may include a first router on a first multicast tree on which the data packet is received. The first multicast tree and a second multicast tree may include a path from the first router to the second router. Thus, the turnaround point may be a first router on a multicast group in which a data packet traveled from a first path associated with a first multicast tree to a second router on a second path associated with a second multicast tree.

The path between the first router and the second router on the first multicast tree (or the second multicast tree) may be filtered from the plurality of paths for the at least one turnaround point at block 204, thereby removing a filtered path for rendering (e.g., as the plurality of filtered paths). By way of example, the filtered path may be removed from rendering so that an operator may observe the presentation of the overlapping multicast tree on a display as including a single path between routers that more accurately reflects the travel of a data packet on a path from a first tree to a second tree.

In an example embodiment, a determination may be made as to whether the second router has routing knowledge that the first multicast tree includes a path between the first router and the second router. The path between the first router and the second router on the first multicast tree (or the second multicast tree) for the at least one turnaround point may be filtered from the plurality of paths when the second router does not have the routing knowledge. In an example embodiment, a path of two or more paths between routers may not be filtered if the path is a parallel path between the routers.

The at least two of the plurality of multicast trees may be rendered for presentation on a display as an overlapping multicast tree at block 206. The overlapping multicast tree may include the filtered plurality of paths for the data packet from the originating router to the selected routers for each of the at least two of the plurality of multicast trees.

Upon completion of the operations at block 206, the method 200 may terminate.

FIG. 3 illustrates a method 300 for rendering an overlapping multicast tree according to an example embodiment. In an example embodiment, the method 300 may be performed during the operations at block 106 and/or block 206 (see FIGS. 1 and 2).

A first multicast tree (e.g. a shared tree or a source tree) may be rendered as an upside down branching tree at block 302. The upside down branching tree may include the plurality of paths for the data packet from the originating router of the first multicast tree to the selected routers of the first multicast tree, where the originating router is at a top of the display and the plurality of paths branch as the plurality of paths head towards the leaves at the bottom of the display. The plurality of paths of the first multicast tree may be in a first presentation format (e.g., a first color, a solid line, a first style, or other identifier).

A second multicast tree (e.g. a shared tree or a source tree) may be rendered as an intersecting tree at block 304, thereby creating an overlapping multicast tree. The intersecting tree may include the plurality of paths for the data packet from the originating router of the second multicast tree to the selected routers of the second multicast tree. The plurality of paths of the intersecting tree may be in a second presentation format (e.g. a second color, a dashed line, a second style, or other identifier). For example, the second multicast tree may be a different type of multicast tree to the first multicast tree and may be rendered as an intersecting tree to the upside down branching tree of the first tree.

The originating router of the first multicast tree need not be the same originating router of the second multicast tree, and the selected routers of the first multicast tree need not be the same selected routers of the second multicast tree.

By displaying the first multicast tree and the second multicast tree simultaneously on a display as an overlapping multicast tree, an administrator may more quickly diagnose a problem with distributing the data packet from a source in a multicast group. Without the simultaneous display as an overlapping multicast tree, the administrator may not have a full picture of how a data packet arrived at a particular router in a multicast group. For example, the administrator may be able to observe a path of a data packet being distributed on a first multicast tree and then on a second multicast tree.

Upon completion of the operations at block 304, the method 300 may terminate.

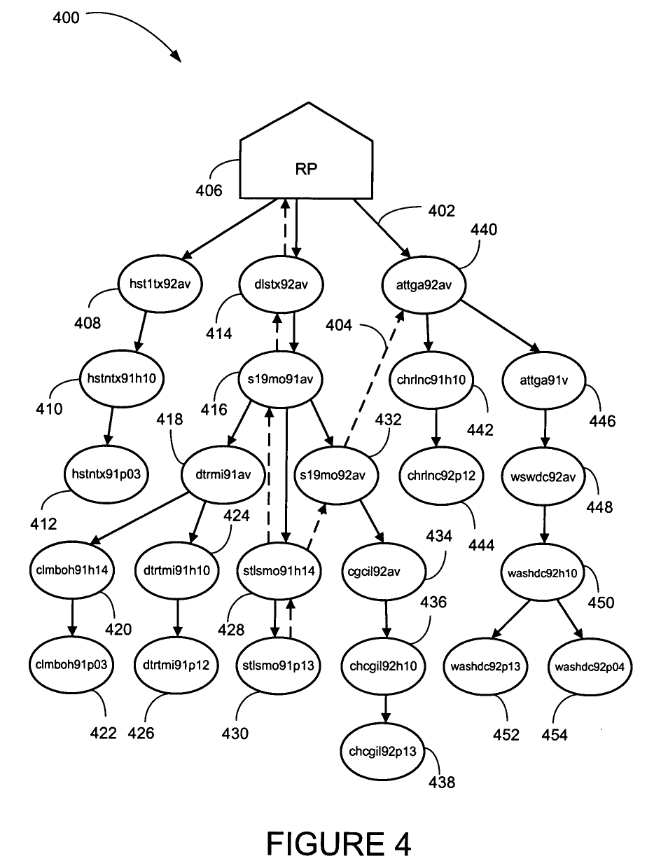

FIG. 4 illustrates an example overlapping multicast tree 400 that may be rendered at the block 106, block 206, and/or by the operations of the method 300 (see FIGS. 1-3). The overlapping multicast tree 400 includes a shared tree rendered as an upside branching tree and a source tree rendered as an intersecting tree to the upside down branching tree. A plurality of paths 402 of the shared tree is shown in a first presentation format (e.g. a solid line with an arrow pointing downward), and a plurality of paths 404 of the source tree is shown in a second presentation format (e.g. a dotted line with an arrow pointing upward).

The root of the shared tree is rendered as illustrated in FIG. 4 at the top of the display, so the direction of packet delivery on the shared tree is “down” with respect to the display. The resulting display including the plurality of paths 402, 404 from at least two multicast trees in a multicast group may make evident to the user how data packets travel from any of the sources included in the overlapping multicast tree to all of the receivers. Specifically, it can be seen that data packets travel “up” (with respect to the direction of the display) on the plurality of paths 404 of the source tree, and at which router(s) the source tree intersects with the shared tree such that packets will head “down” (again with respect to the display) on the plurality of paths 402 of the shared tree. This simultaneous representation may facilitate understanding, debugging, verifying and monitoring network state.

The overlapping multicast tree 400 includes a router designated as a Rendezvous Point (RP) router 406 at the root of the shared tree. The RP router 406 is a multicast enabled router that may form a focal point for receipt and redistribution of the data packets that are the multicast transmission for a particular multicast group. Since the data packets from all sources in the multicast group may be re-transmitted from the RP, the notation (*,G) may be used to represent the shared multicast distribution tree from this point. The wildcard notation “*” refers to all sources for the group (G).

The routers of the overlapping multicast tree 400 are each labeled with their respective router names. The overlapping multicast tree 400 includes the source tree represented as the plurality of paths 404 and the routers 406, 414, 416, 428, 430, 432, 440 and the shared tree represented as the plurality of paths 402 and the routers 406-454.

As illustrated, multicast traffic from a source router 430 travels to the RP router 406 through a router 428, a router 416, and a router 414 on a source tree as indicated by dashed lines from the source router 430. Multicast traffic also flows from the source router 430 on a source tree to a router 440 through a router 428 and a router 432. Multicast traffic flows to the remaining routers through a shared tree indicated by solid lines.

A data packet may be distributed from the source router 430 as follows:
A data packet may be provided from the source router 430 to the router 428. The router 428 may then redistribute the data packet to the router 416 and the router 432.
The router 416 may redistribute the data packet to a router 418 and the router 414. The router 418 may redistribute the data packet to a router 420 and a router 424, which then redistribute the data packet to a router 422 and a router 426 respectively. The router 414 may redistribute the data packet to the RP router 406.
The RP router 406 may redistribute the data packet to a router 408. The router 408 may redistribute the data packet to a router 410, which then may redistribute the data packet to a router 412. The RP router 406 may optionally redistribute the data packet to a router 440.
The router 432 may redistribute the data packet to the router 440. The router 440 may redistribute the data packet to a router 442 and a router 446. The router 442 may redistribute the data packet to a router 444.
The router 446 may redistribute the data packet to a router 448, which may then redistribute the data packet to a router 450. The router 450 may redistribute the data packet to a router 452 and a router 454.

While the overlapping multicast tree 400 is illustrated in FIG. 4 to include a shared tree rendered as an upside branching tree and a source tree rendered as an intersecting tree to the upside branching tree, the source tree may also be rendered as the upside branching tree and the shared tree may be rendered as an intersecting tree to the upside branching tree. Other representations involving multiple tree representations may also be used.

FIG. 5 illustrates an example overlapping multicast tree 500 that may be rendered at the block 106, block 206 and/or by the operations of the method 300 (see FIGS. 1-3). The overlapping multicast tree 500 includes a shared tree rendered as an upside branching tree and a source tree rendered as an intersecting tree to the upside branching tree. A plurality of paths 502 of the shared tree is shown in a first presentation format (e.g. a solid line with an arrow pointing downward), and a plurality of paths 504 of the source tree is shown in a second presentation format (e.g. a dotted line with an arrow pointing upward). A plurality of routers 506-554 is similarly included in a multicast group as a plurality of routers 406-554 (see FIG. 4).

The number of the plurality of paths of 504 included in the overlapping multicast tree 500 is greater than a number of the plurality of paths of 404 included in the overlapping multicast tree 400 as parallel paths (e.g., duplicate paths) have not been filtered (e.g., from the operations at block 204) from the overlapping multicast tree 500. By way of example, the overlapping multicast tree 500 is shown to include parallel paths between a router 516 and a router 524, the router 532 and a router 534, a router 550 and a router 552, and the router 550 and a router 546.

While the overlapping multicast tree 400 includes no parallel paths and the overlapping multicast tree 500 includes a maximum number of parallel paths, a different number of parallel paths may be rendered in a particular overlapping multicast tree.

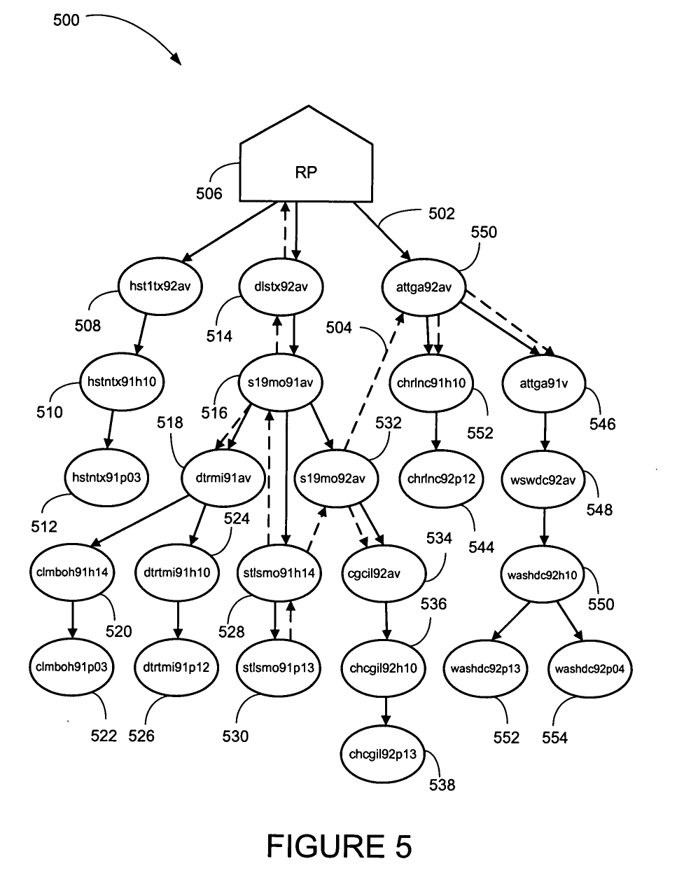

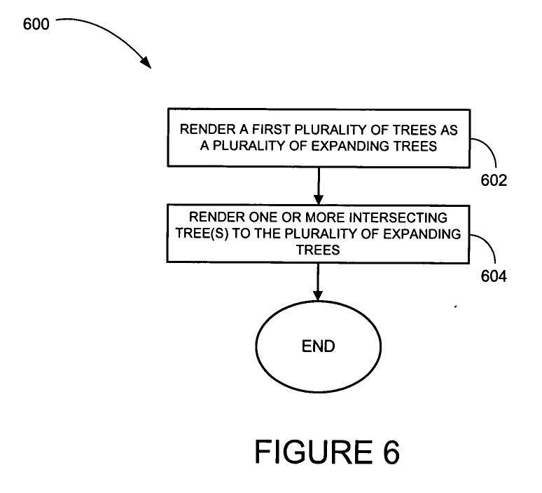

FIG. 6 illustrates a method 600 for rendering an overlapping multicast tree according to an example embodiment. In an example embodiment, the method 600 may be performed at block 106 (see FIG. 1).

A first plurality of trees may be rendered as a plurality of expanding trees at block 602. The root of each of the plurality of expanding trees may be in a portion (e.g., a middle portion) of the display and the plurality of branches may expand (e.g., branch) out from the portion toward other portions (e.g., edges) of the display. The plurality of expanding trees may each include the plurality of paths for the data packet from the originating router of each of the plurality of expanding trees to the selected routers of each of the plurality of expanding trees. The plurality of paths of each of the plurality of expanding trees may be in a different presentation format.

For example, a plurality of source trees (or shared trees) of the at least two of the plurality of multicast trees may be rendered as a plurality of expanding trees from a middle portion of the display.

One or more intersecting trees may be rendered to the plurality of expanding trees at block 604. The intersecting tree may include the plurality of paths for the data packet from the originating router on the intersecting tree to the selected routers on the intersecting tree. The intersecting tree includes at least one router from the expanding trees. The plurality of paths of the intersecting tree may be in an additional presentation format.

For example, a shared tree (or a source tree) or a plurality of source trees (or shared trees) of the at least two of the plurality of multicast trees may be rendered as an intersecting tree to the plurality of expanding trees.

Upon completion of the operations at block 604, the method 600 may terminate.

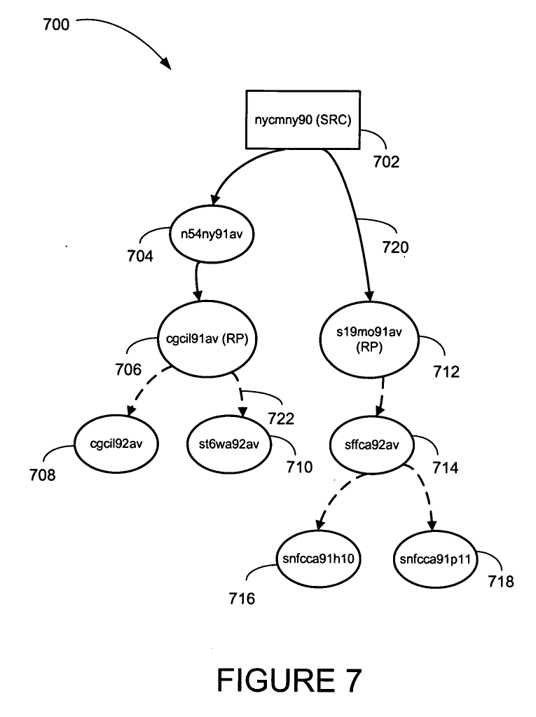

FIG. 7 illustrates an example overlapping multicast tree 700 that may be rendered at the block 106, block 206, and/or by the operations of the method 600 (see FIGS. 1, 2 and 6). The overlapping multicast tree 700 includes a single source router 702 and two RP routers 706, 712. A data packet may be distributed on a source tree from the source router 702 to a router 704 and a RP router 712 over a plurality of paths 720. The router 704 may redistribute the data packet to a RP router 706.

The RP routers 706, 712 may distribute the data packet to a router 708, a router 710, and a router 714 on a plurality of shared trees over a plurality of paths 722. The router 714 may redistribute the data packet to a router 716 and a router 718.

FIG. 8 illustrates an example overlapping multicast tree 800 that may be rendered at the block 106, block 206, and/or by the operations of the method 600 (see FIGS. 1, 2 and 6). The overlapping multicast tree 800 includes two source routers 808, 820 and two RP routers 802, 814.

A data packet may be distributed on a first source tree from the source router 808 to a router 806 and a RP router 814 over a plurality of paths 826. The router 806 may redistribute the data packet to a RP router 802. A data packet may be distributed on a second source tree from the source router 820 to a router 816 over a plurality of paths 824. The router 816 may redistribute the data packet to the RP router 814 and a router 812. The router 812 may redistribute the data packet to the RP router 802.

The RP router 802 may distribute the data packet to a router 804, the router 806, and a router 810 over a plurality of paths 822 associated with a first shared tree. The router 806 may redistribute the data packet to the source router 808. The RP router 814 may distribute the data packet to the router 816 over a plurality of paths 828 associated with a second shared tree. The router 816 may distribute the data packet to the source router 820.

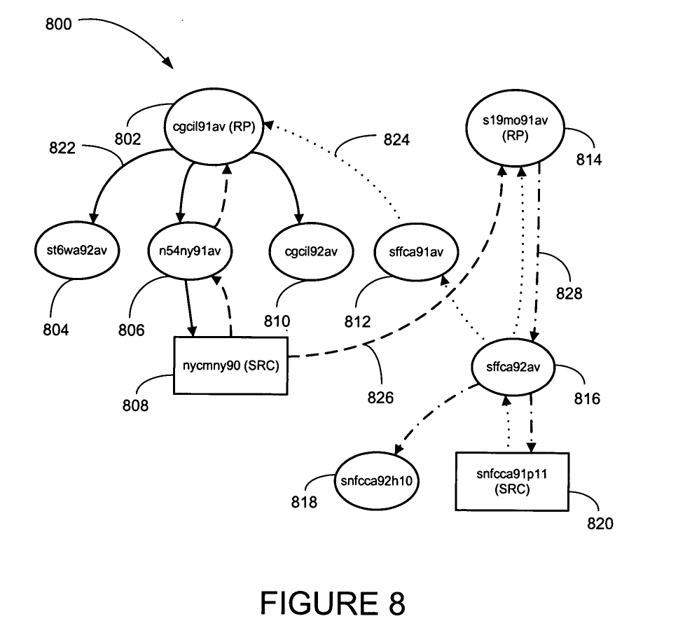

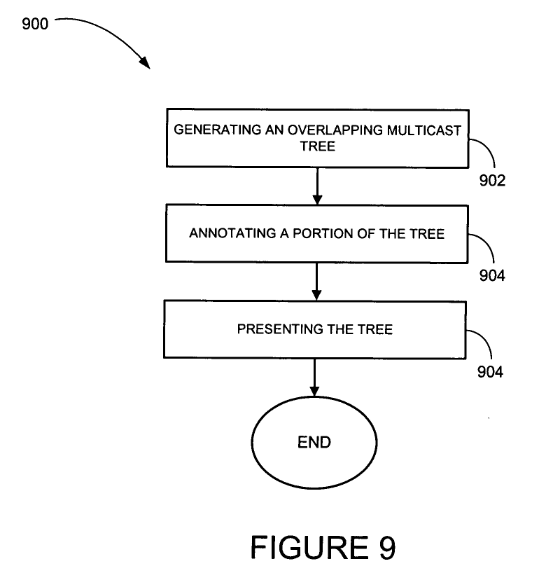

FIG. 9 illustrates a method 900 for rendering an overlapping multicast tree according to an example embodiment. The method 900 may be performed at block 106, block 206, block 302, block 304, block 602, and/or block 604 (see FIGS. 1-3 and 6).

At least two of the plurality of multicast trees may be generated as an overlapping multicast tree on a display at block 902. For example, the block 902 may include the operations selected from the method 100, the method 200, the method 300, and/or the method 600 (see FIGS. 1-3 and 6). The generated overlapping multicast tree may include the plurality of paths for the data packet from the originating router to the selected routers for each of the at least two of the plurality of multicast trees but may not yet be presented on a display.

The originating router, the selected routers, and/or the plurality of paths of the overlapping multicast tree may be annotated with status information regarding the overlapping multicast tree at block 904. For example, the annotated status information may be made available directly on the display with the overlapping multicast tree, may be made available by an administrator's selection on the overlapping multicast tree, or may otherwise be made available. The status information may include network health information regarding a multicast tree of the at least two of the plurality of multicast trees or per-group distribution rate of a number of data packets for the overlapping multicast tree. Other status information may also be used. For example, the network health may include status of routers, data transmission rate, and the like.

The annotated overlapping multicast tree may be presented on a display at block 906.

Upon completion of the operations at block 906, the method 900 may terminate.

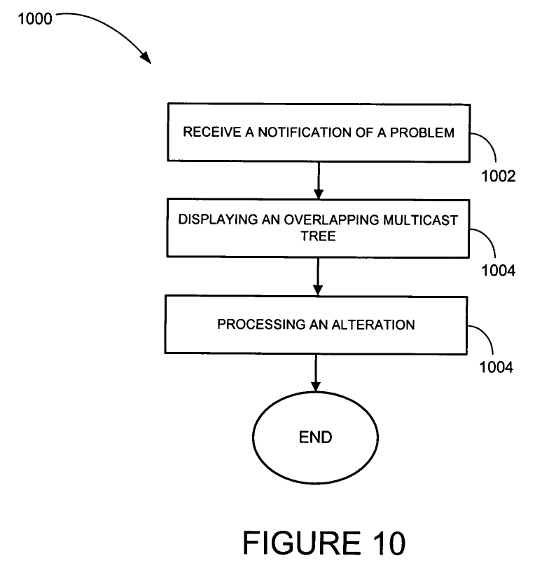

FIG. 10 illustrates a method 1000 for addressing a problem in a network in accordance with an example embodiment. The method 1000 may use the method 100 for displaying a plurality of multicast trees (see FIG. 1) to resolve a problem on a network.

A notification of a problem may be received regarding a network at block 1002. The network may include a plurality of routers.

At least two of a plurality of multicast trees may be displayed as an overlapping multicast tree at block 1004.

An alteration for the network may be processed at block 1006. The alteration may be capable of at least partially resolving the problem regarding the network. The problem regarding the network may be a router problem with at least one router of the plurality of routers, however other problems regarding the network may also be at least partially resolved.

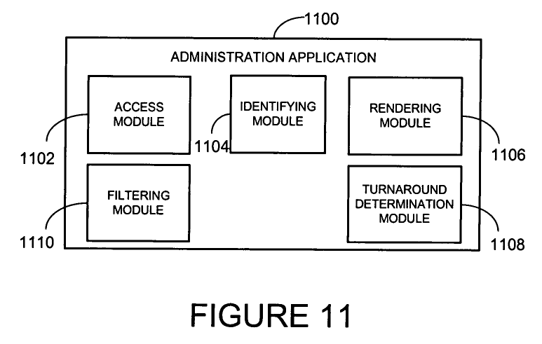

FIG. 11 illustrates an example administration application 1100 which may perform the methods 100-300, 600, 900 (see FIGS. 1-3, 6, and 9).

An access module 1102 accesses a multicast routing state from a plurality of routers in a multicast group. An identifying module 1104 identifies a plurality of multicast trees from the multicast routing state of the plurality of routers. Each of the plurality of multicast trees may indicate a plurality of paths for a data packet from an originating router to selected routers among the plurality of routers.

A rendering module 1106 renders at least two of the plurality of multicast trees on a display as an overlapping multicast tree. The overlapping multicast tree may include the plurality of paths for the data packet from the originating router to the selected routers for each of the at least two of the plurality of multicast trees.

A turnaround determination module 1108 identifies at least one turnaround point on at least two of the plurality of multicast trees. A filtering module 1110 filters the path between the first router and the second router on the first multicast tree or the second multicast tree from the plurality of paths for the at least one turnaround point.

The plurality of multicast trees includes at least one source tree and at least one shared tree. The originating router and the selected routers may be all routers of the plurality of routers, or a subset of routers from the plurality of routers. The multicast group may include a plurality of multicast groups to enable display of the plurality of multicast groups simultaneously on the same display. The multicast group used to display the overlapping multicast tree may support services provided in a network such as a VPN service an internet protocol television (IPTV) service, and the like.

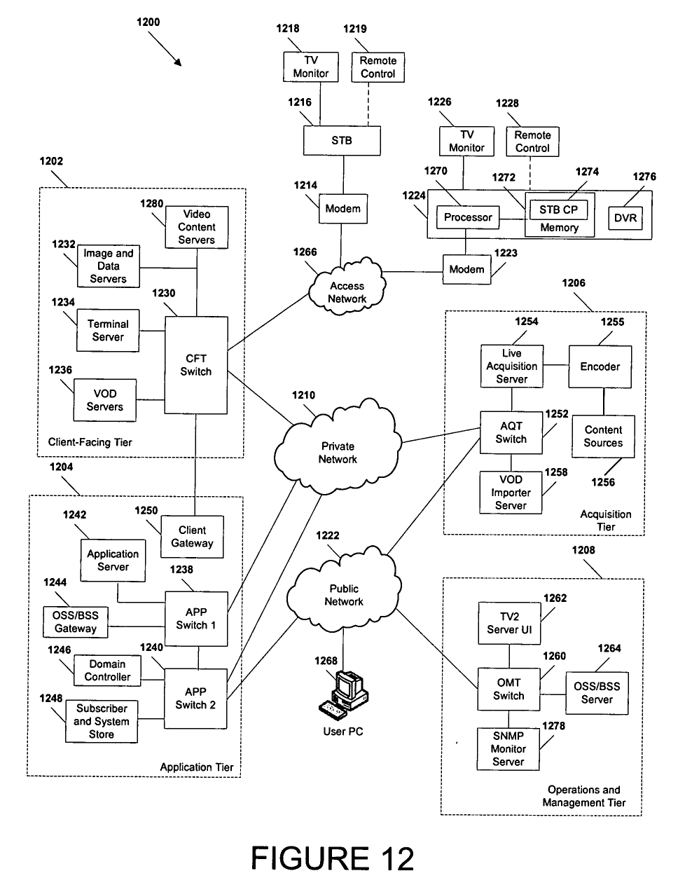

FIG. 12 illustrates an example embodiment of an Internet Protocol Television (IPTV) system 1200 in which multicast signals used to provide content (e.g., IPTV content). The distribution of content in the form of data packets may be observed by an administrator by viewing an overlapping multicast tree as described in greater detail above. An overlapping multicast tree may also be displayed for other systems in which data packets are multicast beyond the system 1200.

As shown, the system 1200 may include a client facing tier 1202, an application tier 1204, an acquisition tier 1206, and an operations and management tier 1208. Each tier 1202, 1204, 1206, 1208 is coupled to a private network 1210; to a public network 1222, such as the Internet; or to both the private network 1210 and the public network 1222. For example, the client-facing tier 1202 may be coupled to the private network 1210. Further, the application tier 1204 may be coupled to the private network 1210 and to the public network 1222. The acquisition tier 1206 may also be coupled to the private network 1210 and to the public network 1222. Additionally, the operations and management tier 1208 may be coupled to the public network 1222.

As illustrated in FIG. 12, the various tiers 1202, 1204, 1206, 1208 communicate with each other via the private network 1210 and the public network 1222. For instance, the client-facing tier 1202 may communicate with the application tier 1204 and the acquisition tier 1206 via the private network 1210. The application tier 1204 may also communicate with the acquisition tier 1206 via the private network 1210. Further, the application tier 1204 may communicate with the acquisition tier 1206 and the operations and management tier 1208 via the public network 1222. Moreover, the acquisition tier 1206 may communicate with the operations and management tier 1208 via the public network 1222. In a particular embodiment, elements of the application tier 1204, including, but not limited to, a client gateway 1250, may communicate directly with the client-facing tier 1202.

As illustrated in FIG. 12, the client-facing tier 1202 may communicate with user equipment via a private access network 1266, such as an Internet Protocol Television (IPTV) access network. In an illustrative embodiment, modems, such as a first modem 1214 and a second modem 1223 may be coupled to the private access network 1266. The client-facing tier 1202 may communicate with a first representative set-top box device 1216 via the first modem 1214 and with a second representative set-top box device 1224 via the second modem 1212. The client-facing tier 1202 may communicate with a large number of set-top boxes, such as the representative set-top boxes 1216, 1224, over a wide geographic area, such as a regional area, a metropolitan area, a viewing area, a designated market area or any other suitable geographic area, market area, or subscriber or customer group that may be supported by networking the client-facing tier 1202 to numerous set-top box devices. In an illustrative embodiment, the client-facing tier, or any portion thereof, may be included at a video head-end office.

In a particular embodiment, the client-facing tier 1202 may be coupled to the modems 1214, 1223 via fiber optic cables. Alternatively, the modems 1214 and 1223 may be digital subscriber line (DSL) modems that are coupled to one or more network nodes via twisted pairs, and the client-facing tier 1202 may be coupled to the network nodes via fiber-optic cables. Each set-top box device 1216, 1224 may process data received via the private access network 1266, via an IPTV software platform, such as Microsoft® TV IPTV Edition. In another embodiment, representative set-top boxes 1216, 1224 may receive data from private access network 1266 through RF and other cable and/or satellite based networks.

Additionally, the first set-top box device 1216 may be coupled to a first external display device, such as a first television monitor 1218, and the second set-top box device 1224 may be coupled to a second external display device, such as a second television monitor 1226. Moreover, the first set-top box device 1216 may communicate with a first remote control 1219, and the second set-top box device may communicate with a second remote control 1228.

In an example, non-limiting embodiment, each set-top box device 1216, 1224 may receive video content, which may include video and audio portions, from the client-facing tier 1202 via the private access network 1266. The set-top boxes 1216, 1224 may transmit the video content to an external display device, such as the television monitors 1218, 1226. Further, the set-top box devices 1216, 1224 may each include a STB processor, such as STB processor 1270, and a STB memory device, such as STB memory 1272, which is accessible to the STB processor 1270. In one embodiment, a computer program, such as the STB computer program 1274, may be embedded within the STB memory device 1272. Each set-top box device 1216, 1224 may also include a video content storage module, such as a digital video recorder (DVR) 1276. In a particular embodiment, the set-top box devices 1216, 1224 may communicate commands received from the remote control devices 1219, 1228 to the client-facing tier 1202 via the private access network 1266.

In an illustrative embodiment, the client-facing tier 1202 may include a client-facing tier (CFT) switch 1230 that manages communication between the client-facing tier 1202 and the private access network 1266 and between the client-facing tier 1202 and the private network 1210. As shown, the CFT switch 1230 is coupled to one or more image and data servers 1232 that store still images associated with programs of various IPTV channels. The image and data servers 1232 may also store data related to various channels, e.g., types of data related to the channels and to programs or video content displayed via the channels. In an illustrative embodiment, the image and data servers 1232 may be a cluster of servers, each of which may store still images, channel and program-related data, or any combination thereof. The CFT switch 1230 may also be coupled to a terminal server 1234 that provides terminal devices with a connection point to the private network 1210. In a particular embodiment, the CFT switch 1230 may also be coupled to one or more video-on-demand (VOD) servers 1236 that store or provide VOD content imported by the IPTV system 1200. In an illustrative, non-limiting embodiment, the VOD content servers 1280 may include one or more unicast servers.

The client-facing tier 1202 may also include one or more video content servers 1280 that transmit video content requested by viewers via their set-top boxes 1216, 1224. In an illustrative, non-limiting embodiment, the video content servers 1280 may include one or more multicast servers.

As illustrated in FIG. 12, the application tier 1204 may communicate with both the private network 1210 and the public network 1222. The application tier 1204 may include a first application tier (APP) switch 1238 and a second APP switch 1240. In a particular embodiment, the first APP switch 1238 may be coupled to the second APP switch 1240. The first APP switch 1238 may be coupled to an application server 1242 and to an OSS/BSS gateway 1244. In a particular embodiment, the application server 1242 may provide applications to the set-top box devices 1216, 1224 via the private access network 1266, which enable the set-top box devices 1216, 1224 to provide functions, such as display, messaging, processing of IPTV data and VOD material, etc. In a particular embodiment, the OSS/BSS gateway 1244 includes operation systems and support (OSS) data, as well as billing systems and support (BSS) data. In one embodiment, the OSS/BSS gateway may provide or restrict access to an OSS/BSS server 1264 that stores operations and billing systems data.

Further, the second APP switch 1240 may be coupled to a domain controller 1246 that provides web access, for example, to users via the public network 1222. For example, the domain controller 1246 may provide remote web access to IPTV account information via the public network 1222, which users may access using their personal computers 1268. The second APP switch 1240 may be coupled to a subscriber and system store 1248 that includes account information, such as account information that is associated with users who access the system 1200 via the private network 1210 or the public network 1222. In a particular embodiment, the application tier 1204 may also include a client gateway 1250 that communicates data directly with the client-facing tier 1202. In this embodiment, the client gateway 1250 may be coupled directly to the CFT switch 1230. The client gateway 1250 may provide user access to the private network 1210 and the tiers coupled thereto.

In a particular embodiment, the set-top box devices 1216, 1224 may access the IPTV system 1200 via the private access network 1266, using information received from the client gateway 1250. In this embodiment, the private access network 1266 may provide security for the private network 1210. User devices may access the client gateway 1250 via the private access network 1266, and the client gateway 1250 may allow such devices to access the private network 1210 once the devices are authenticated or verified. Similarly, the client gateway 1250 may prevent unauthorized devices, such as hacker computers or stolen set-top box devices from accessing the private network 1210, by denying access to these devices beyond the private access network 1266.

For example, when the first representative set-top box device 1216 accesses the system 1200 via the private access network 1266, the client gateway 1250 may verify subscriber information by communicating with the subscriber and system store 1248 via the private network 1210, the first APP switch 1238, and the second APP switch 1240. Further, the client gateway 1250 may verify billing information and status by communicating with the OSS/BSS gateway 1244 via the private network 1210 and the first APP switch 1238. In one embodiment, the OSS/BSS gateway 1244 may transmit a query across the first APP switch 1238, to the second APP switch 1240, and the second APP switch 1240 may communicate the query across the public network 1222 to the OSS/BSS server 1264. After the client gateway 1250 confirms subscriber and/or billing information, the client gateway 1250 may allow the set-top box device 1216 access to IPTV content and VOD content. If the client gateway 1250 is unable to verify subscriber information for the set-top box device 1216, e.g., because it is connected to an unauthorized twisted pair, the client gateway 1250 may block transmissions to and from the set-top box device 1216 beyond the private access network 1266.

As indicated in FIG. 12, the acquisition tier 1206 includes an acquisition tier (AQT) switch 1252 that communicates with the private network 1210. The AQT switch 1252 may also communicate with the operations and management tier 1208 via the public network 1222. In a particular embodiment, the AQT switch 1252 may be coupled to a live acquisition server 1254 that receives television or movie content, for example, from content sources 1256 through an encoder 1255. In a particular embodiment during operation of the IPTV system, the live acquisition server 1254 may acquire television or movie content. The live acquisition server 1254 may transmit the television or movie content to the AQT switch 1252 and the AQT switch 1252 may transmit the television or movie content to the CFT switch 1230 via the private network 1210.

Further, the television or movie content may be transmitted to the video content servers 1280, where it may be encoded, formatted, stored, or otherwise manipulated and prepared for communication to the set-top box devices 1216, 1224. The CFT switch 1230 may communicate the television or movie content to the modems 1214, 1223 via the private access network 1266. The set-top box devices 1216, 1224 may receive the television or movie content via the modems 1214, 1213, and may transmit the television or movie content to the television monitors 1218, 1226. In an illustrative embodiment, video or audio portions of the television or movie content may be streamed to the set-top box devices 1216, 1224.

Further, the AQT switch may be coupled to a video-on-demand importer server 1258 that stores television or movie content received at the acquisition tier 1206 and communicates the stored content to the VOD server 1236 at the client-facing tier 1202 via the private network 1210. Additionally, at the acquisition tier 1206, the video-on-demand (VOD) importer server 1258 may receive content from one or more VOD sources outside the IPTV system 1200, such as movie studios and programmers of non-live content. The VOD importer server 1258 may transmit the VOD content to the AQT switch 1252, and the AQT switch 1252, in turn, may communicate the material to the CFT switch 1230 via the private network 1210. The VOD content may be stored at one or more servers, such as the VOD server 1236.

When user issue requests for VOD content via the set-top box devices 1216, 1224, the requests may be transmitted over the private access network 1266 to the VOD server 1236, via the CFT switch 1230. Upon receiving such requests, the VOD server 1236 may retrieve the requested VOD content and transmit the content to the set-top box devices 1216, 1224 across the private access network 1266, via the CFT switch 1230. The set-top box devices 1216, 1224 may transmit the VOD content to the television monitors 1218, 1226. In an illustrative embodiment, video or audio portions of VOD content may be streamed to the set-top box devices 1216, 1224.

FIG. 12 further illustrates that the operations and management tier 1208 may include an operations and management tier (OMT) switch 1260 that conducts communication between the operations and management tier 1208 and the public network 1222. In the embodiment illustrated by FIG. 1, the OMT switch 1260 is coupled to a TV2 server 1262. Additionally, the OMT switch 1260 may be coupled to an OSS/BSS server 1264 and to a simple network management protocol (SNMP) monitor 1270 that monitors network devices within or coupled to the IPTV system 1200. In a particular embodiment, the OMT switch 1260 may communicate with the AQT switch 1252 via the public network 1222.

In an illustrative embodiment, the live acquisition server 1254 may transmit the television or movie content to the AQT switch 1252, and the AQT switch 1252, in turn, may transmit the television or movie content to the OMT switch 1260 via the public network 1222. In this embodiment, the OMT switch 1260 may transmit the television or movie content to the TV2 server 1262 for display to users accessing the user interface at the TV2 server 1262. For example, a user may access the TV2 server 1262 using a personal computer (PC) 1268 coupled to the public network 1222.

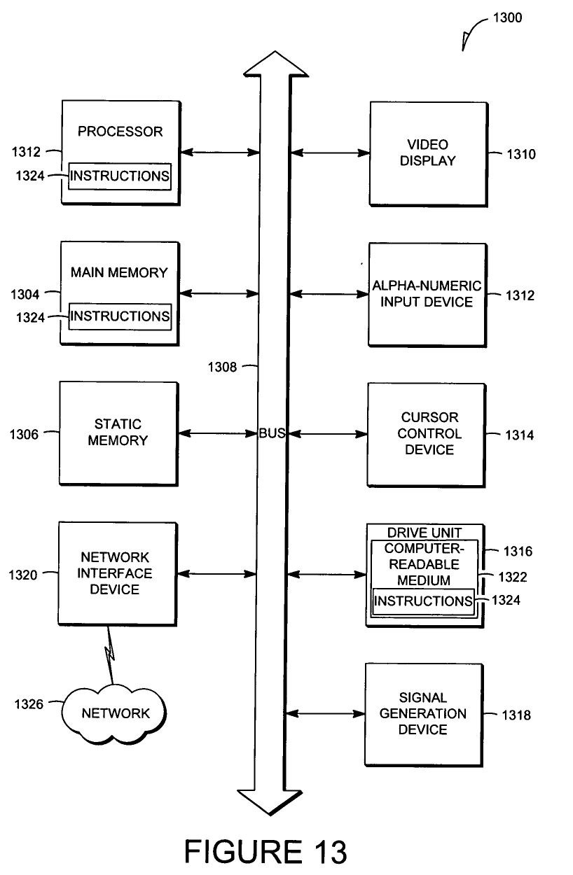

FIG. 13 shows a diagrammatic representation of machine in the example form of a computer system 1300 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1312 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device 1314 (e.g., a mouse), a disk drive unit 1316, a signal generation device 1318 (e.g., a speaker) and a network interface device 1320.

The disk drive unit 1316 includes a machine-readable medium 1322 on which is stored one or more sets of instructions and data structures (e.g., software 1324) embodying or utilized by any one or more of the methodologies or functions described herein. The software 1324 may also reside, completely or at least partially, within the main memory 1304 and/or within the processor 1312 during execution thereof by the computer system 1300, the main memory 1304 and the processor 1312 also constituting machine-readable media.

The software 1324 may further be transmitted or received over a network 1326 via the network interface device 1320 utilizing any one of a number of well-known transfer protocols (e.g., HTTP).

While the machine-readable medium 1322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a multicast routing state from a plurality of routers in a multicast group, the multicast routing state including identification of at least one of an upstream router or a downstream router;
identifying a plurality of multicast trees from the multicast routing state of the plurality of routers, each of the plurality of multicast trees indicating a plurality of paths for a data packet from an originating router to selected routers among the plurality of routers; and
rendering at least two of the plurality of multicast trees on a display as an overlapping multicast tree, the overlapping multicast tree including the plurality of paths for the data packet from the originating router to the selected routers for each of the at least two of the plurality of multicast trees.

2. The method of claim 1, wherein accessing a multicast routing state from a plurality of routers in a multicast group comprises:
receiving a multicast group address and an address of at least one sender; and
accessing a multicast routing state from a plurality of routers in a multicast group in response to the multicast group address and the address of at least one sender, the multicast routing state including identification of at least one of an upstream router or a downstream router

3. The method of claim 2, wherein identifying a plurality of multicast trees from the multicast routing state of the plurality of routers comprises:
identifying a shared tree using the multicast group address; and
identifying at least one source tree using the address of the at least one sender, the shared tree and the at least one source tree each indicating a plurality of paths for a data packet from an originating router to selected routers among the plurality of routers.

4. The method of claim 1, where rendering at least two of the plurality of multicast trees on a display as an overlapping multicast tree comprises:
identifying at least one turnaround point on at least two of the plurality of multicast trees, the at least one turnaround point being a first router on a first multicast tree on which the data packet is received, the first multicast tree and a second multicast tree including a path from the first router to the second router;
filtering the path between the first router and the second router on the first multicast tree from the plurality of paths for the at least one turnaround point; and
rendering the at least two of the plurality of multicast trees on a display as an overlapping multicast tree, the overlapping multicast tree including the filtered plurality of paths for the data packet from the originating router to the selected routers for each of the at least two of the plurality of multicast trees.

5. The method of claim 4, wherein filtering the path between the first router and the second router on the first multicast tree comprises:
determining whether the second router has routing knowledge that the first multicast tree includes a path between the first router and the second router; and
filtering the path between the first router and the second router on the first multicast tree from the plurality of paths for the at least one turnaround point when the second router does not have the routing knowledge.

6. The method of claim 1, wherein rendering at least two of the plurality of multicast trees on a display as an overlapping multicast tree comprises:
rendering a shared tree of the at least two of the plurality of multicast trees as an upside down branching tree, the upside down branching tree including the plurality of paths for the data packet from the originating router to the selected routers, the plurality of paths of the shared tree being in a first presentation format; and
rendering a source tree of the at least two of the plurality of multicast trees as an intersecting tree to the upside down branching tree, the intersecting tree including the plurality of paths for the data packet from the originating router to the selected routers, the plurality of paths of the source tree being in a second presentation format.

7. The method of claim 1, wherein rendering at least two of the plurality of multicast trees on a display as an overlapping multicast tree comprises:
rendering a source tree of the at least two of the plurality of multicast trees as an upside down branching tree, the upside down branching multicast tree including the plurality of paths for the data packet from the originating router to the selected routers, the plurality of paths of the upside down branching tree being in a first presentation format; and
rendering a shared tree of the at least two of the plurality of multicast trees as an intersecting tree to the source tree, the intersecting tree including the plurality of paths for the data packet from the originating router to the selected routers, the plurality of paths of the intersecting tree being in a second presentation format.

8. The method of claim 7, wherein the first presentation format is a first color and the second presentation format is a second color.

9. The method of claim 1, wherein rendering at least two of the plurality of multicast trees on a display as an overlapping multicast tree comprises:
rendering a plurality of source trees of the at least two of the plurality of multicast trees as a plurality of expanding trees from a middle portion of the display, the plurality of expanding trees each including the plurality of paths for the data packet from the originating router to the selected routers, the plurality of paths of each of the plurality of expanding trees in a different presentation format; and
rendering a shared tree of the at least two of the plurality of multicast trees as an intersecting tree to the plurality of expanding trees, the intersecting tree including the plurality of paths for the data packet from the originating router to the selected routers, the plurality of paths of the intersecting tree in an additional presentation format.

10. The method of claim 1, wherein rendering at least two of the plurality of multicast trees on a display as an overlapping multicast tree comprises:
rendering a plurality of shared trees of the at least two of the plurality of multicast trees as a plurality of expanding trees from a middle portion of the display, the plurality of expanding trees each including the plurality of paths for the data packet from the originating router to the selected routers, the plurality of paths of each of the plurality of expanding trees being in a different presentation format; and
rendering a plurality of source trees of the at least two of the plurality of multicast trees as a plurality of intersecting trees on the plurality of expanding trees, the plurality of intersecting trees each including the plurality of paths for the data packet from the originating router to the selected routers, the plurality of paths of each of the plurality of intersecting trees each being in an additional presentation format.

11. The method of claim 1, wherein rendering at least two of the plurality of multicast trees on a display as an overlapping multicast tree comprises:
rendering at least two of the plurality of multicast trees on a display as an overlapping multicast tree, the overlapping multicast tree indicating the plurality of paths of a data packet from the originating router to the selected routers for each of the at least two of the plurality of multicast trees, each of the plurality of paths of a first multicast tree including a plurality of arrows pointing in an upward facing direction on the display, each of the plurality of paths of a second multicast tree including the plurality of arrows pointing in a downward facing direction on the display.

12. The method of claim 1, wherein rendering at least two of the plurality of multicast trees on a display as an overlapping multicast tree comprises:
generating at least two of the plurality of multicast trees on a display as an overlapping multicast tree, the overlapping multicast tree including the plurality of paths for the data packet from the originating router to the selected routers for each of the at least two of the plurality of multicast trees;
annotating at least one of the originating router, the selected routers, or the plurality of paths of the overlapping multicast tree with status information regarding the overlapping multicast tree; and
presenting the annotated overlapping multicast tree on a display.

13. The method of claim 12, wherein the status information is at least one of:
network health information regarding a multicast tree of the at least two of the plurality of multicast trees, or
per-group distribution rate of a number of data packets for the overlapping multicast tree.

14. The method of claim 1, further comprising:
receiving an information request for a router chosen from the group of routers from an administrator; and
presenting information regarding the multicast routing entry of the chosen router on the display in response to the information request.

15. An apparatus comprising:
an access module to access a multicast routing state from a plurality of routers in a multicast group, the multicast routing state including identification of at least one of an upstream router or a downstream router;
an identifying module to identify a plurality of multicast trees from the multicast routing state of the plurality of routers, each of the plurality of multicast trees indicating a plurality of paths for a data packet from an originating router to selected routers among the plurality of routers; and
a rendering module to render at least two of the plurality of multicast trees on a display as an overlapping multicast tree, the overlapping multicast tree including the plurality of paths for the data packet from the originating router to the selected routers for each of the at least two of the plurality of multicast trees.

16. The apparatus of claim 15, further comprising:
a turnaround determination module to identify at least one turnaround point on at least two of the plurality of multicast trees, the at least one turnaround point being a first router on a first multicast tree on which the data packet is received, the first multicast tree and a second multicast tree including a path from the first router to the second router; and
a filtering module to filter the path between the first router and the second router on the first multicast tree from the plurality of paths for the at least one turnaround point.

17. The apparatus of claim 15, wherein the plurality of multicast trees includes at least one source tree and at least one shared tree.

18. The apparatus of claim 15, wherein the originating router and the selected routers are all routers of the plurality of routers.

19. The apparatus of claim 15, wherein the multicast group is a plurality of multicast groups.

20. The apparatus of claim 15, wherein the multicast group supports services provided in a network selected from a group of services consisting of a virtual private network (VPN) service and an internet protocol television (IPTV) service.

21. A machine-readable medium comprising instructions, which when executed by a machine, cause the machine to:
access a multicast routing state from a plurality of routers in a multicast group, the multicast routing state including identification of at least one of an upstream router or a downstream router;
identify a plurality of multicast trees from the multicast routing state of the plurality of routers, each of the plurality of multicast trees indicating a plurality of paths for a data packet from an originating router to selected routers among the plurality of routers; and
render at least two of the plurality of multicast trees on a display as an overlapping multicast tree, the overlapping multicast tree including the plurality of paths for the data packet from the originating router to the selected routers for each of the at least two of the plurality of multicast trees.

22. The machine-readable medium of claim 21, wherein causing the machine to render at least two of the plurality of multicast trees on a display as an overlapping multicast tree causes the machine to:
identify at least one turnaround point on at least two of the plurality of multicast trees, the at least one turnaround point being a first router on a first multicast tree on which the data packet is received, the first multicast tree and a second multicast tree including a path from the first router to the second router;
filter the path between the first router and the second router on the first multicast tree from the plurality of paths for the at least one turnaround point; and
render the at least two of the plurality of multicast trees on a display as an overlapping multicast tree, the overlapping multicast tree including the filtered plurality of paths for the data packet from the originating router to the selected routers for each of the at least two of the plurality of multicast trees.

23. The machine-readable medium of claim 21, wherein causing the machine to render at least two of the plurality of multicast trees on a display as an overlapping multicast tree causes the machine to:
render a shared tree of the at least two of the plurality of multicast trees as an upside down branching tree, the upside down branching tree including the plurality of paths for the data packet from the originating router to the selected routers, the plurality of paths of the shared tree in a first presentation format; and
render a source tree of the at least two of the plurality of multicast trees as an intersecting tree to the shared tree, the intersecting tree including the plurality of paths for the data packet from the originating router to the selected routers, the plurality of paths of the source tree in a second presentation format.

24. The machine-readable medium of claim 21, wherein causing the machine to render at least two of the plurality of multicast trees on a display as an overlapping multicast tree causes the machine to:
render a source tree of the at least two of the plurality of multicast trees as an upside down branching tree, the upside down branching multicast tree including the plurality of paths for the data packet from the originating router to the selected routers, the plurality of paths of the upside down branching tree in a first presentation format; and
render a shared tree of the at least two of the plurality of multicast trees as an intersecting tree to the source tree, the intersecting tree including the plurality of paths for the data packet from the originating router to the selected routers, the plurality of paths of the intersecting tree in a second presentation format.

25. The machine-readable medium of claim 21, wherein causing the machine to render at least two of the plurality of multicast trees on a display as an overlapping multicast tree causes the machine to:
render a plurality of source trees of the at least two of the plurality of multicast trees as a plurality of expanding trees from a middle portion of the display, the plurality of expanding trees each including the plurality of paths for the data packet from the originating router to the selected routers, the plurality of paths of each of the plurality of expanding trees in a different presentation format; and
render a shared tree of the at least two of the plurality of multicast trees as an intersecting tree to the plurality of expanding trees, the intersecting tree including the plurality of paths for the data packet from the originating router to the selected routers, the plurality of paths of the intersecting tree in an additional presentation format.

26. A method comprising:
displaying at least two of a plurality of multicast trees as an overlapping multicast tree, the overlapping multicast tree including the plurality of paths for a data packet from an originating router to one or more selected routers for each of at least two of the plurality of multicast trees.

27. The method of claim 26, where displaying at least two of a plurality of multicast trees as an overlapping multicast tree comprises:
identifying at least one turnaround point on at least two of a plurality of multicast trees, the at least one turnaround point being a first router on a first multicast tree on which the data packet is received, the first multicast tree and a second multicast tree including a path from the first router to the second router;
filtering the path between the first router and the second router on the first multicast tree from the plurality of paths for the at least one turnaround point; and
displaying the at least two of the plurality of multicast trees as an overlapping multicast tree, the overlapping multicast tree including the filtered plurality of paths for the data packet from the originating router to the selected routers for each of the at least two of the plurality of multicast trees.

28. The method of claim 26, wherein display at least two of a plurality of multicast trees as an overlapping multicast tree comprises:
rendering a shared tree of the at least two of the plurality of multicast trees as an upside down branching tree, the upside down branching tree including the plurality of paths for the data packet from the originating router to the selected routers, the plurality of paths of the shared tree being in a first presentation format; and
rendering a source tree of the at least two of the plurality of multicast trees as an intersecting tree to the upside down branching tree, the intersecting tree including the plurality of paths for the data packet from the originating router to the selected routers, the plurality of paths of the source tree being in a second presentation format.

29. The method of claim 26, wherein displaying at least two of a plurality of multicast trees as an overlapping multicast tree comprises:
displaying a source tree of the at least two of a plurality of multicast trees as an upside down branching tree, the upside down branching multicast tree including a plurality of paths for the data packet from an originating router to one or more selected routers, the plurality of paths of the upside down branching tree being in a first presentation format; and
displaying a shared tree of the at least two of the plurality of multicast trees as an intersecting tree to the source tree, the intersecting tree including the plurality of paths for the data packet from the originating router to the one or more selected routers, the plurality of paths of the intersecting tree being in a second presentation format.

30. The method of claim 26, wherein displaying at least two of a plurality of multicast trees as an overlapping multicast tree comprises:
displaying in a middle portion of a display a plurality of source trees of at least two of the plurality of multicast trees as a plurality of expanding trees, the plurality of expanding trees each including a plurality of paths for a data packet from an originating router to one or more selected routers, the plurality of paths of each of the plurality of expanding trees in a different presentation format; and
displaying a shared tree of the at least two of the plurality of multicast trees as an intersecting tree to the plurality of expanding trees, the intersecting tree including the plurality of paths for the data packet from the originating router to the one or more selected routers, the plurality of paths of the intersecting tree in an additional presentation format.

31. The method of claim 26, wherein displaying at least two of a plurality of multicast trees as an overlapping multicast tree comprises:
displaying in a middle portion of a display a plurality of shared trees of at least two of the plurality of multicast trees as a plurality of expanding trees, the plurality of expanding trees each including a plurality of paths for a data packet from an originating router to one or more selected routers, the plurality of paths of each of the plurality of expanding trees being in a different presentation format; and
displaying a plurality of source trees of the at least two of the plurality of multicast trees as a plurality of intersecting trees on the plurality of expanding trees, the plurality of intersecting trees each including the plurality of paths for the data packet from the originating router to the selected routers, the plurality of paths of each of the plurality of intersecting trees each being in an additional presentation format.

32. The method of claim 26, wherein displaying at least two of a plurality of multicast trees as an overlapping multicast tree comprises:
displaying at least two of a plurality of multicast trees as an overlapping multicast tree, the overlapping multicast tree indicating a plurality of paths of a data packet from an originating router to one or more selected routers for each of the at least two of the plurality of multicast trees, each of the plurality of paths of a first multicast tree including a plurality of arrows pointing in an upward facing direction on the display, each of the plurality of paths of a second multicast tree including the plurality of arrows pointing in a downward facing direction on the display.

33. A method comprising:
displaying at least two of a plurality of multicast trees as an overlapping multicast tree, the overlapping multicast tree including a plurality of paths for a data packet in a network from an originating router to one or more selected routers for each of at least two of the plurality of multicast trees, the overlapping multicast tree including information used to identify a problem within the network; and
processing an alteration for the network, the alteration capable of at least partially resolving the problem regarding the network.

34. The method of claim 33, wherein displaying at least two of a plurality of multicast trees as an overlapping multicast tree comprises:
receiving a notification of a problem regarding a network, the network including a plurality of routers;
displaying at least two of a plurality of multicast trees as an overlapping multicast tree, the overlapping multicast tree including a plurality of paths for a data packet in the network from an originating router to one or more selected routers for each of at least two of the plurality of multicast trees, the overlapping multicast tree including information used to identify the problem within the network.

35. The method of claim 33, wherein the problem regarding a network is a router problem with at least one router of the plurality of routers.
